(19) United States
(12) Patent Application Publication
(10) Pub. No.: US 2019/0100305 A1
(43) Pub. Date: Apr. 4, 2019

(54) Faired Tether Systems with Tail Span Sections

(71) Applicant: X Development LLC, Mountain View, CA (US)

(72) Inventors: Elias Wolfgang Patten, Seattle, WA (US); Matthew Shapiro, San Francisco, CA (US); Jérôme Sicard, Oakland, CA (US)

(21) Appl. No.: 16/130,176

(22) Filed: Sep. 13, 2018

Related U.S. Application Data
(60) Provisional application No. 62/567,459, filed on Oct. 3, 2017.

(51) Int. Cl. B64C 39/02; B64F 3/02

(52) U.S. Cl. CPC B64C 39/022; B64F 3/02

(57) ABSTRACT

Systems including tethers with one or more attached airfoil tails are described. Some systems include reversibly deformable struts that attach the tails to a tether to allow for stretch of the tether when the tether is under tension. The form of the tails may vary along the length of the tether to account for different aerodynamic design considerations.

### CROSS REFERENCE TO RELATED APPLICATION

This application claims priority to U.S. Patent Application No. 62/567,459, filed on Oct. 3, 2017, which is incorporated herein by reference in its entirety and for all purposes.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, such as utility systems. As one example, a wind energy system may convert kinetic wind energy to electrical energy.

### SUMMARY

Systems with faired tethers (i.e., tethers formed in the shape of an airfoil) with tail spans (“tails”) attached via struts are described herein.

In one aspect, a tether system may include a ground station, an aerial vehicle, a tether coupled between the ground station and the aerial vehicle. The tether may include a tether body and an electrical conductor and the tether may take the form of a first airfoil shape with a leading edge of the tether, a trailing edge of the tether, and a tether chord length. The system may further include a plurality of tails and each tail may take the form of a respective airfoil shape that includes, respectively, a chord length, a span length, a leading edge, and a trailing edge. Each tail may be disposed at a respective distance from the tether and coupled to the tether by at least two struts. Each tail may be oriented such that the leading edge of the respective tail is nearer the tether than the trailing edge of the respective tail.

In another aspect, a tether system may include a tether with a tether body and an electrical conductor. The tether may take the form of a first airfoil shape with a leading edge of the tether, a trailing edge of the tether, and a tether chord length. The tether system may further include a strut with an interior segment extending through the tether body, a bottom locking tab extending at a first angle relative to the interior segment and along a first exterior surface of the tether body, a riser portion extending outward from the tether body at a second angle to the tether chord length, a top locking tab extending at a third angle from the riser portion and along a second exterior surface of the tether opposite the first exterior surface of the tether, and an extension portion extending from the riser portion in a trailing direction.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 depicts an Airborne Wind Turbine (AWT), according to an example embodiment.

FIG. 2 is a simplified block diagram illustrating components of an AWT, according to an example embodiment.

FIG. 3 depicts an aerial vehicle of an AWT, according to an example embodiment.

FIG. 4 depicts an aerial vehicle coupled to a ground station via a tether, according to an example embodiment.

FIG. 5 depicts an AWT with a faired tether with tail span sections, according to an example embodiment.

FIG. 6A depicts a faired tether and tail in an unstretched condition, according to an example embodiment.

FIG. 6B depicts a faired tether and tail in a stretched condition, according to an example embodiment.

FIG. 6C depicts a section view of a faired tether, according to an example embodiment.

FIG. 6D depicts a section view of a faired tether, according to an example embodiment.

FIG. 7A depicts a faired tether and tail, according to an example embodiment.

FIG. 7B depicts a section view of a faired tether, according to an example embodiment.

FIG. 7C depicts a section view of a faired tether, according to an example embodiment.

FIG. 8 depicts a strut in a section view of a faired tether, according to an example embodiment.

FIG. 9A depicts a side view of a strut, according to an example embodiment.

FIG. 9B depicts a rear view of a strut, according to an example embodiment.

FIG. 10A depicts a faired tether and tail, according to an example embodiment.

FIG. 10B depicts a faired tether and tail, according to an example embodiment.

FIG. 10C depicts a faired tether and tail, according to an example embodiment.

### DETAILED DESCRIPTION

Exemplary systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems can be arranged and combined in a wide variety of different configurations, all of which are contemplated herein.

### I. OVERVIEW

Illustrative embodiments relate to components which may be used in a wind energy system, such as an Airborne Wind Turbine (AWT). In particular, illustrative embodiments may relate to or take the form of faired tethers with tail span sections that may be used in AWTs.

An AWT may include an aerial vehicle that flies in a closed path, such as a substantially circular path, to convert kinetic wind energy to electrical energy. In an illustrative implementation, the aerial vehicle may be connected to a ground station via a tether. While tethered, the aerial vehicle can: (i) fly at a range of elevations and substantially along the path, and return to the ground, and (ii) transmit electrical energy to the ground station via the tether. In some implementations, the ground station may transmit electricity to the aerial vehicle for take-off and/or landing.

In an AWT, an aerial vehicle may rest in and/or on a ground station (or a separate perch) when the wind is not conducive to power generation. When the wind is conducive to power generation, such as when a wind speed may be 3.5 meters per second (m/s) at an altitude of 200 meters, the ground station may deploy (or launch) the aerial vehicle. In addition, when the aerial vehicle is deployed and the wind is not conducive to power generation, the aerial vehicle may return to the ground station.

The aerial vehicle may be configured for hover flight and crosswind flight. Crosswind flight may be used to travel in a motion, such as a substantially circular motion, and thus may be the primary technique that is used to generate electrical energy. Hover flight in turn may be used by the aerial vehicle to prepare and position itself for crosswind flight. In particular, the aerial vehicle could ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some implementations, the aerial vehicle may vertically ascend or descend in hover flight. Moreover, in crosswind flight, the aerial vehicle may be oriented such that the aerial vehicle may be propelled by the wind substantially along a closed path, which as noted above, may convert kinetic wind energy to electrical energy. In some implementations, one or more rotors of the aerial vehicle may generate electrical energy by slowing down the incident wind.

Embodiments described herein include tethers. Tethers described herein may be configured to withstand one or more forces when the aerial vehicle is in flight (e.g., tension from aerodynamic forces acting on the aerial vehicle), and configured to transmit electricity between the aerial vehicle and the ground station. Tethers described herein include faired tethers (i.e., tethers formed in the shape of an airfoil) with tail spans (“tails”) attached via struts to the faired tether.

To reduce or eliminate flutter in faired tethers, it is desirable to move the aerodynamic center rearwards without also moving the center of mass rearwards. Embodiments described herein use one or more separate tail spans connected via struts to the main faired tether body to accomplish this. The small planform surface area of the tails act through the moment arm from the struts to generate significant force creating an aerodynamic moment that orients the main faired tether body into the wind. As a results, the embodiments described herein create a large effect on the aerodynamic center with very little weight penalty, thus having a minimal effect on the center of gravity. The struts attaching the tail to the tether body are preferably stiff enough in bending and torsion such that the tail won't flutter, as the tail's center of gravity is behind the tail's aerodynamic center. In embodiments described herein, at least 2 struts per tail may be used, particularly for larger tails. This greatly stiffens the tail in bending across the thickness axis and in torsion.

In an illustrative implementation, a tether may include a strength core within a tether body. The strength core may include various numbers of strength members, including one or more strength members. The strength members may be formed in various different cross-section shapes. Additionally, a tether may include one or more electrical conductors, which may be referred to as a conductor bundle. The electrical conductors may be individually insulated. The strength core and the electrical conductors may be bundled together in a core bundle.

### II. ILLUSTRATIVE SYSTEMS

A. Airborne Wind Turbine (AWT)

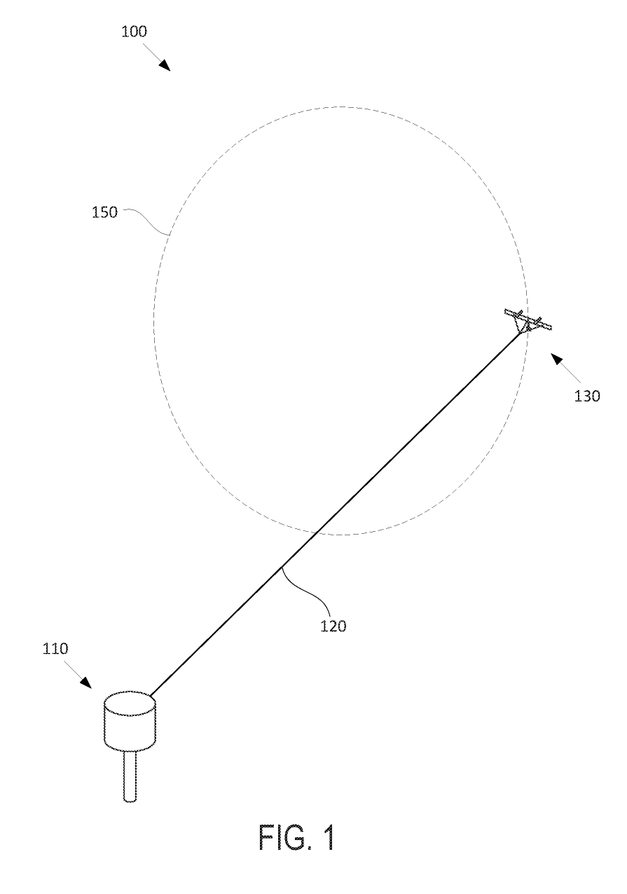

FIG. 1 depicts an AWT 100, according to an example embodiment. In particular, the AWT 100 includes a ground station 110, a tether 120, and an aerial vehicle 130. As shown in FIG. 1, the tether 120 may be connected to the aerial vehicle on a first end and may be connected to the ground station 110 on a second end. In this example, the tether 120 may be attached to the ground station 110 at one location on the ground station 110, and attached to the aerial vehicle 130 at three locations on the aerial vehicle 130. However, in other examples, the tether 120 may be attached at one or more locations to any part of the ground station 110 and/or the aerial vehicle 130.

The ground station 110 may be used to hold and/or support the aerial vehicle 130 until it is in an operational mode. The ground station 110 may also be configured to allow for the repositioning of the aerial vehicle 130 such that deploying of the aerial vehicle 130 is possible. Further, the ground station 110 may be further configured to receive the aerial vehicle 130 during a landing. The ground station 110 may be formed of any material or materials that can suitably keep the aerial vehicle 130 attached and/or anchored to the ground while in hover flight, crosswind flight, and other flight modes, such as forward flight (which may be referred to as airplane-like flight). In some implementations, a ground station 110 may be configured for use on land. However, a ground station 110 may also be implemented on a body of water, such as a lake, river, sea, or ocean. For example, a ground station could include or be arranged on a floating off-shore platform or a boat, among other possibilities. Further, a ground station 110 may be configured to remain stationary or to move relative to the ground or the surface of a body of water.

In addition, the ground station 110 may include one or more components (not shown), such as a winch, that may vary a deployed length of the tether 120. For example, when the aerial vehicle 130 is deployed, the one or more components may be configured to pay out and/or reel in the tether 120. In some implementations, the one or more components may be configured to pay out and/or reel in the tether 120 to a predetermined length. As examples, the predetermined length could be equal to or less than a maximum length of the tether 120. Further, when the aerial vehicle 130 lands in the ground station 110, the one or more components may be configured to reel in the tether 120.

The tether 120 may transmit electrical energy generated by the aerial vehicle 130 to the ground station 110. In addition, the tether 120 may transmit electrical energy to the aerial vehicle 130 in order to power the aerial vehicle 130 for takeoff, landing, hover flight, and/or forward flight. The tether 120 may use materials that may allow for the transmission, delivery, and/or harnessing of electrical energy generated by the aerial vehicle 130 and/or transmission of electricity to the aerial vehicle 130. The tether 120 may also be configured to withstand one or more forces of the aerial vehicle 130 when the aerial vehicle 130 is in an operational mode. For example, the tether 120 may include a strength core configured to withstand one or more forces of the aerial vehicle 130 when the aerial vehicle 130 is in hover flight, forward flight, and/or crosswind flight. In one example, the tether 120 may have a length of 100 meters or more.

The aerial vehicle 130 may be configured to fly substantially along a closed path 150 to generate electrical energy. The term “substantially along,” as used in this disclosure, refers to exactly along and/or one or more deviations from exactly along that do not significantly impact generation of electrical energy.

The aerial vehicle 130 may include or take the form of various types of devices, such as a kite, a helicopter, a wing and/or an airplane, among other possibilities. The aerial vehicle 130 may be formed of metal, plastic and/or other polymers. The aerial vehicle 130 may be formed of materials that allow for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction.

The closed path 150 may be various different shapes in various different embodiments. For example, the closed path 150 may be substantially circular. And in at least one such example, the closed path 150 may have a radius of up to 265 meters. The term “substantially circular,” as used in this disclosure, refers to exactly circular and/or one or more deviations from exactly circular that do not significantly impact generation of electrical energy as described herein. Other shapes for the closed path 150 may be an oval, such as an ellipse, the shape of a jelly bean, the shape of the number of 8, etc.

The aerial vehicle 130 may be operated to travel along one or more revolutions of the closed path 150.

B. Illustrative Components of an AWT

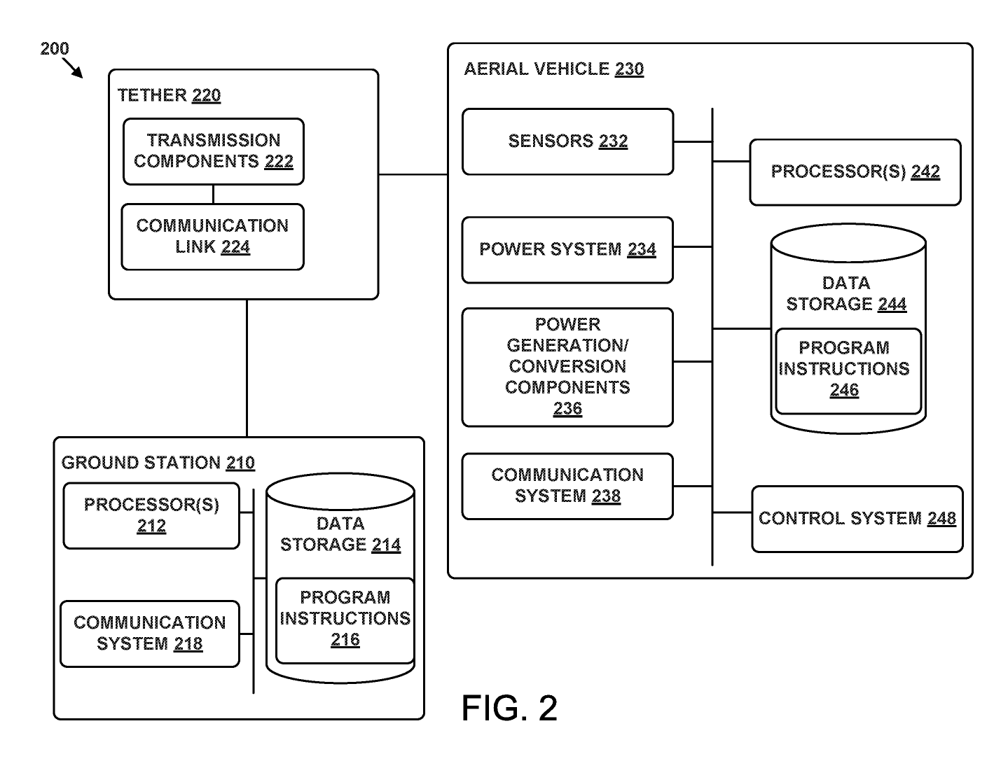

FIG. 2 is a simplified block diagram illustrating components of an AWT 200. The AWT 100 may take the form of or be similar in form to the AWT 200. In particular, the AWT 200 includes a ground station 210, a tether 220, and an aerial vehicle 230. The ground station 110 may take the form of or be similar in form to the ground station 210, the tether 120 may take the form of or be similar in form to the tether 220, and the aerial vehicle 130 may take the form of or be similar in form to the aerial vehicle 230.

As shown in FIG. 2, the ground station 210 may include one or more processors 212, data storage 214, and program instructions 216. A processor 212 may be a general-purpose processor or a special purpose processor (e.g., digital signal processors, application specific integrated circuits, etc.). The one or more processors 212 can be configured to execute computer-readable program instructions 216 that are stored in a data storage 214 and are executable to provide at least part of the functionality described herein.

The data storage 214 may include or take the form of one or more computer-readable storage media that may be read or accessed by at least one processor 212. The one or more computer-readable storage media can include volatile and/or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments, the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include a communication system 218. The communication system 218 may include one or more wireless interfaces and/or one or more wireline interfaces, which allow the ground station 210 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ground station 210 may communicate with the aerial vehicle 230, other ground stations, and/or other entities (e.g., a command center) via the communication system 218.

In an example embodiment, the ground station 210 may include communication systems 218 that allows for both short-range communication and long-range communication. For example, the ground station 210 may be configured for short-range communications using Bluetooth and for long-range communications under a CDMA protocol. In such an embodiment, the ground station 210 may be configured to function as a “hot spot”; or in other words, as a gateway or proxy between a remote support device (e.g., the tether 220, the aerial vehicle 230, and other ground stations) and one or more data networks, such as cellular network and/or the Internet. Configured as such, the ground station 210 may facilitate data communications that the remote support device would otherwise be unable to perform by itself.

For example, the ground station 210 may provide a WiFi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command center, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 and/or transmit electrical energy from the ground station 210 to the aerial vehicle 230. The transmission components 222 may take various different forms in various different embodiments. For example, the transmission components 222 may include one or more electrical conductors that are configured to transmit electricity. And in at least one such example, the one or more electrical conductors may include aluminum and/or any other material which allows for the conduction of electric current. Moreover, in some implementations, the transmission components 222 may surround a core of the tether 220 (not shown).

The ground station 210 could communicate with the aerial vehicle 230 via the communication link 224. The communication link 224 may be bidirectional and may include one or more wired and/or wireless interfaces. Also, there could be one or more routers, switches, and/or other devices or networks making up at least a part of the communication link 224.

Further, as shown in FIG. 2, the aerial vehicle 230 may include one or more sensors 232, a power system 234, power generation/conversion components 236, a communication system 238, one or more processors 242, data storage 244, program instructions 246, and a control system 248.

The sensors 232 could include various different sensors in various different embodiments. For example, the sensors 232 may include a global positioning system (GPS) receiver. The GPS receiver may be configured to provide data that is typical of well-known GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to detect apparent and/or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEMS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, slight errors in measurement may compound over time and result in a more significant error. However, an example aerial vehicle 230 may be able to mitigate or reduce such errors by using a magnetometer to measure direction. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of and/or prevent drift of the IMU. In addition, the aerial vehicle 230 may include one or more load cells configured to detect forces distributed between a connection of the tether 220 to the aerial vehicle 230.

As noted, the aerial vehicle 230 may include the power system 234. The power system 234 could take various different forms in various different embodiments. For example, the power system 234 may include one or more batteries for providing power to the aerial vehicle 230. In some implementations, the one or more batteries may be rechargeable and each battery may be recharged via a wired connection between the battery and a power supply and/or via a wireless charging system, such as an inductive charging system that applies an external time-varying magnetic field to an internal battery and/or charging system that uses energy collected from one or more solar panels.

As another example, the power system 234 may include one or more motors or engines for providing power to the aerial vehicle 230. In some implementations, the one or more motors or engines may be powered by a fuel, such as a hydrocarbon-based fuel. And in such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 236 could take various different forms in various different embodiments. For example, the power generation/conversion components 236 may include one or more generators, such as high-speed, direct-drive generators. With this arrangement, the one or more generators may be driven by one or more rotors. And in at least one such example, the one or more generators may operate at full rated power wind speeds of 11.5 meters per second at a capacity factor which may exceed 60 percent, and the one or more generators may generate electrical power from 40 kilowatts to 600 megawatts.

Moreover, as noted, the aerial vehicle 230 may include a communication system 238. The communication system 238 may take the form of or be similar in form to the communication system 218. The aerial vehicle 230 may communicate with the ground station 210, other aerial vehicles, and/or other entities (e.g., a command center) via the communication system 238.

In some implementations, the aerial vehicle 230 may be configured to function as a “hot spot”; or in other words, as a gateway or proxy between a remote support device (e.g., the ground station 210, the tether 220, other aerial vehicles) and one or more data networks, such as cellular network and/or the Internet. Configured as such, the aerial vehicle 230 may facilitate data communications that the remote support device would otherwise be unable to perform by itself.

For example, the aerial vehicle 230 may provide a WiFi connection to the remote device, and serve as a proxy or gateway to a cellular service provider's data network, which the aerial vehicle 230 might connect to under an LTE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 246, and the data storage 244. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems and/or with hardware, firmware, and/or software. As one example, the control system 248 may take the form of program instructions stored on a non-transitory computer readable medium and a processor that executes the instructions. The control system 248 may be implemented in whole or in part on the aerial vehicle 230 and/or at least one entity remotely located from the aerial vehicle 230, such as the ground station 210. Generally, the manner in which the control system 248 is implemented may vary, depending upon the particular application.

While the aerial vehicle 230 has been described above, it should be understood that the methods and systems described herein could involve any suitable aerial vehicle that is connected to a tether, such as the tether 220 and/or the tether 120.

C. Illustrative Aerial Vehicle

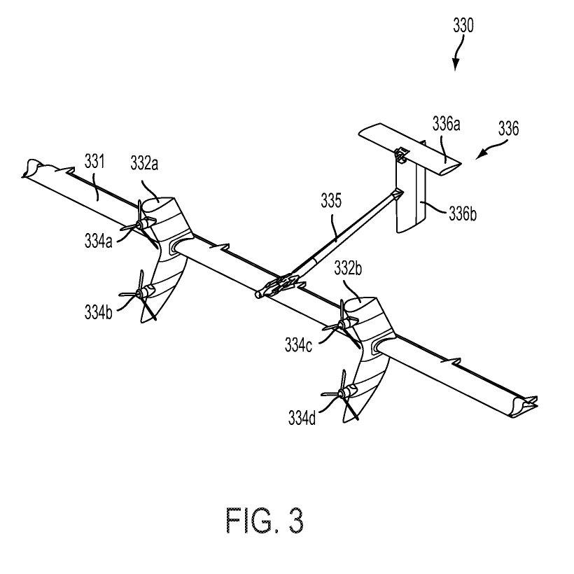

FIG. 3 depicts an aerial vehicle 330, according to an example embodiment. The aerial vehicle 130 and/or the aerial vehicle 230 may take the form of or be similar in form to the aerial vehicle 330. In particular, the aerial vehicle 330 may include a main wing 331, pylons 332a, 332b, rotors 334a, 334b, 334c, 334d, a tail boom 335, and a tail wing assembly 336. Any of these components may be shaped in any form which allows for the use of components of lift to resist gravity and/or move the aerial vehicle 330 forward.

The main wing 331 may provide a primary lift force for the aerial vehicle 330. The main wing 331 may be one or more rigid or flexible airfoils, and may include various control surfaces, such as winglets, flaps (e.g., Fowler flaps, Hoerner flaps, split flaps, and the like), rudders, elevators, spoilers, dive brakes, etc. The control surfaces may be used to stabilize the aerial vehicle 330 and/or reduce drag on the aerial vehicle 330 during hover flight, forward flight, and/or crosswind flight.

The main wing 331 and pylons 332a, 332b may be any suitable material for the aerial vehicle 330 to engage in hover flight, forward flight, and/or crosswind flight. For example, the main wing 331 and pylons 332a, 332b may include carbon fiber and/or e-glass, and include internal supporting spars or other structures. Moreover, the main wing 331 and pylons 332a, 332b may have a variety of dimensions. For example, the main wing 331 may have one or more dimensions that correspond with a conventional wind turbine blade. As another example, the main wing 331 may have a span of 8 meters, an area of 4 meters squared, and an aspect ratio of 15.

The pylons 332a, 332b may connect the rotors 334a, 334b, 334c, and 334d to the main wing 331. In some examples, the pylons 332a, 332b may take the form of, or be similar in form to, a lifting body airfoil (e.g., a wing). In some examples, a vertical spacing between corresponding rotors (e.g., rotor 334a and rotor 334b on pylon 332a) may be 0.9 meters.

The rotors 334a, 334b, 334c, and 334d may be configured to drive one or more generators for the purpose of generating electrical energy. In this example, the rotors 334a, 334b, 334c, and 334d may each include one or more blades, such as three blades or four blades. The rotor blades may rotate via interactions with the wind and be used to drive the one or more generators. In addition, the rotors 334a, 334b, 334c, and 334d may also be configured to provide thrust to the aerial vehicle 330 during flight. With this arrangement, the rotors 334a, 334b, 334c, and 334d may function as one or more propulsion units, such as a propeller. Although the rotors 334a, 334b, 334c, and 334d are depicted as four rotors in this example, in other examples the aerial vehicle 330 may include any number of rotors, such as less than four rotors or more than four rotors (e.g., eight rotors).

A tail boom 335 may connect the main wing 331 to the tail wing assembly 336, which may include a tail wing 336a and a vertical stabilizer 336b. The tail boom 335 may have a variety of dimensions. For example, the tail boom 335 may have a length of 2 meters. Moreover, in some implementations, the tail boom 335 could take the form of a body and/or fuselage of the aerial vehicle 330. In such implementations, the tail boom 335 may carry a payload.

The tail wing 336a and/or the vertical stabilizer 336b may be used to stabilize the aerial vehicle 330 and/or reduce drag on the aerial vehicle 330 during hover flight, forward flight, and/or crosswind flight. For example, the tail wing 336a and/or the vertical stabilizer 336b may be used to maintain a pitch of the aerial vehicle 330 during hover flight, forward flight, and/or crosswind flight. The tail wing 336a and the vertical stabilizer 336b may have a variety of dimensions. For example, the tail wing 336a may have a length of 2 meters. Moreover, in some examples, the tail wing 336a may have a surface area of 0.45 meters squared. Further, in some examples, the tail wing 336a may be located 1 meter above a center of mass of the aerial vehicle 330.

While the aerial vehicle 330 has been described above, it should be understood that the systems described herein could involve any suitable aerial vehicle that is connected to an airborne wind turbine tether, such as the tether 120 and/or the tether 220.

D. Aerial Vehicle Coupled to a Ground Station Via a Tether

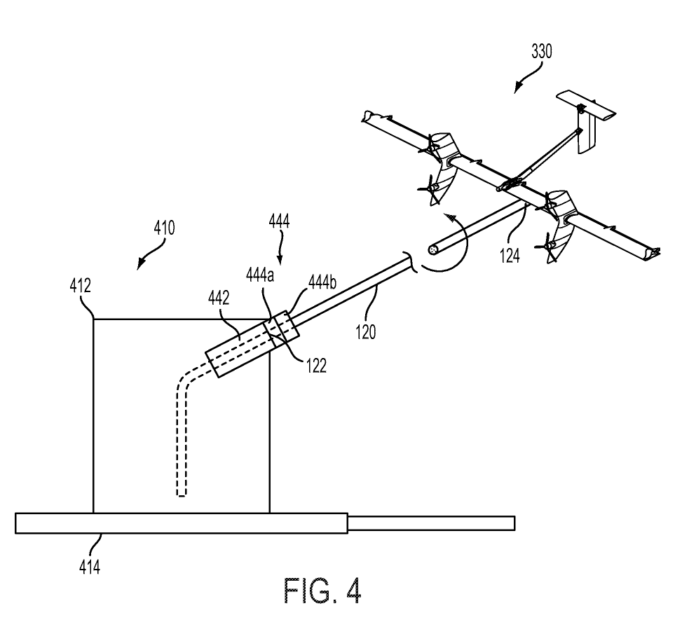

FIG. 4 depicts the aerial vehicle 330 coupled to a ground station 410 via the tether 120, according to an example embodiment. Referring to FIG. 4, the ground station 410 may include a winch drum 412 and a platform 414. The ground station 110 and/or the ground station 210 may take the form of or be similar in form to the ground station 410. FIG. 4 is for illustrative purposes only and may not reflect all components or connections.

As shown in FIG. 4, the tether 120 may be coupled to a tether gimbal assembly 442 at a proximate tether end 122 and to the aerial vehicle 330 at a distal tether end 124. Additionally or alternatively, at least a portion of the tether 120 (e.g., at least one electrical conductor) may pass through the tether gimbal assembly 442. In some embodiments, the tether 120 may terminate at the tether gimbal assembly 442. Moreover, as shown in FIG. 4, the tether gimbal assembly 442 may also be coupled to the winch drum 412 which in turn may be coupled to the platform 414. In some embodiments, the tether gimbal assembly 442 may be configured to rotate about one or more axes, such as an altitude axis and an azimuth axis, in order to allow the proximate tether end 122 to move in those axes in response to movement of the aerial vehicle 330.

A rotational component 444 located between the tether 120 and the tether gimbal assembly 442 may allow the tether 120 to rotate about a long axis of the tether 120. The long axis is defined as extending between the proximate tether end 122 and the distal tether end 124. In some embodiments, at least a portion of the tether 120 may pass through the rotational component 444. Moreover, in some embodiments, the tether 120 may pass through the rotational component 444. Further, in some embodiments, the rotational component 444 may include a fixed portion 444a and a rotatable portion 444b, for example, in the form of one or more bearings and/or slip rings. The fixed portion 444a may be coupled to the tether gimbal assembly 442. The rotatable portion 444b may be coupled to the tether 120.

The use of the word fixed in the fixed portion 444a of the rotational component 444 is not intended to limit fixed portion 444a to a stationary configuration. In this example, the fixed portion 444a may move in axes described by the tether gimbal assembly 442 (e.g., altitude and azimuth), and may rotate about the ground station 410 as the winch drum 412 rotates, but the fixed portion 444a will not rotate about the tether 120, i.e., with respect to the long axis of the tether 120. Moreover, in this example, the rotatable portion 444b of the rotational component 444 may be coupled to the tether 120 and configured to substantially rotate with the rotation of tether 120.

Via the rotational component 444, the tether 120 may rotate about its centerline along the long axis as the aerial vehicle 330 orbits. The distal tether end 124 may rotate a different amount then the proximate tether end 122, resulting in an amount of twist along the length of the tether 420. With this arrangement, the amount of twist in the tether 420 may vary based on a number of parameters during crosswind flight of the aerial vehicle 330.

E. Illustrative Tethers

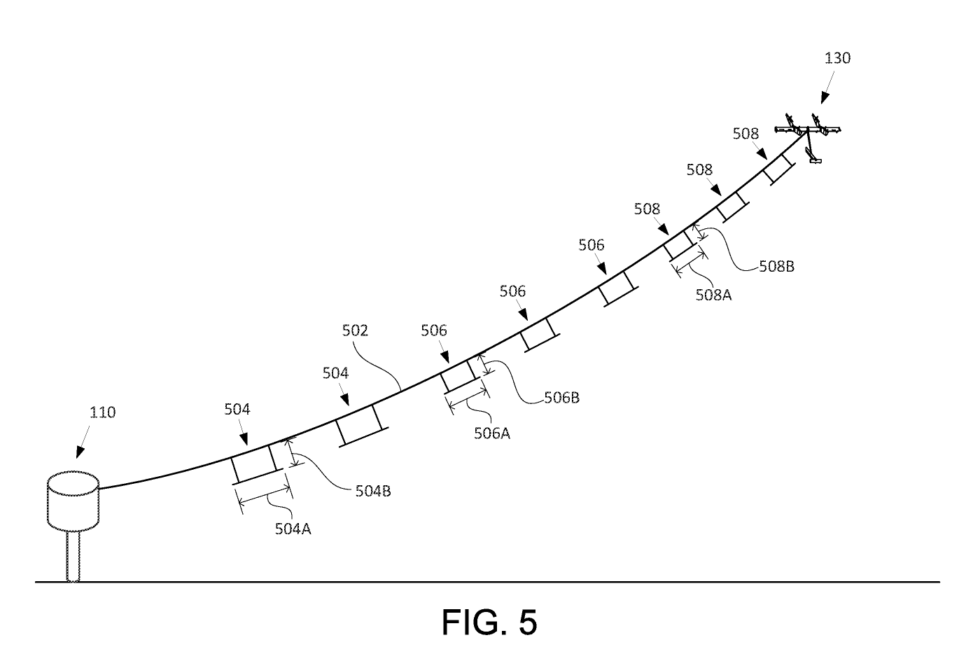

FIG. 5 depicts a tether 502, according to an example embodiment. The tether 120 and/or the tether 220 may take the form of or be similar in form to the tether 502. FIG. 5 and the remaining Figures depicting tethers are for illustrative purposes only and may not reflect all components or connections. Further, as illustrations, the Figures may not reflect actual operating conditions, but are merely to illustrate aspects of embodiments described. For example, while a perfectly straight tether may be used to illustrate a described tether embodiment, during orbiting crosswind flight the tether may in practice exhibit some level of droop between the ground station and the aerial vehicle. Further still, the relative dimensions in the Figures may not be to scale, but are merely to illustrate the embodiments described.

Tether 502 connects an illustrative aerial vehicle 130 to an illustrative ground station 110. Tether 502 may be a faired tether, as described further with respect to Figures below. Tail spans are illustrated as trailing below the tether 502. A first set of tails 504 are each located at a distance 504B from the tether 502. Each tail 504 in the first set has a span length 504A. Similarly, a second set of tails 506 are each located at a distance 506B from the tether 502 and each have a span length 506A. A third set of tails 508 are each located at a distance 508B from the tether 502 and each have a span length 508A. In this embodiment, the first set of tails 504 is located nearer to the ground station 110 along the tether 502 than the second set of tails 506. Similarly, the second set of tails 506 is located nearer to the ground station 110 along the tether 502 than the third set of tails 508. The number of tails and tail sets illustrated in FIG. 5 are illustrative only and more or fewer may be present.

As shown in the illustrative embodiment, it may be desirable to change the tail and strut design along the length of the tether to accommodate different airspeed velocities and relative angles of attack along the length of the tether 502 during crosswind flight. For example, near the aerial vehicle, the relative angle of attack is mostly dominated by kite speed, and hence mostly constant along the flight path. Where the airspeeds are greatest and the tether 502 is most subject to flutter, it may be preferable to use shorter and/or stiffer struts. Thus the distance 508B from each tail 508 to the tether 502 is shorter than the distances 506B and 504B farther down along the tether 502. Nearer the ground station, the airspeed of the tether 502 becomes relatively lower and the aerodynamic moment capability of a tail may be correspondingly lower. Additionally, the tether 502 is less likely to flutter and the angle of attack shear is greater. Therefore, it may be desirable to use longer struts and/or larger tails to keep the tether 502 aligned with the relative wind. Very near the ground station 110, where the contribution of tether drag on the kite is lowest, it may be desirable to use no tails. Other changes beyond span length and the distance from the tether may also be enacted to change the aerodynamic effect of the tail on the tether. For example, the airfoil shape or angles of attack of individual tails may be varied according to the tail's position along the length of the tether, or other factors.

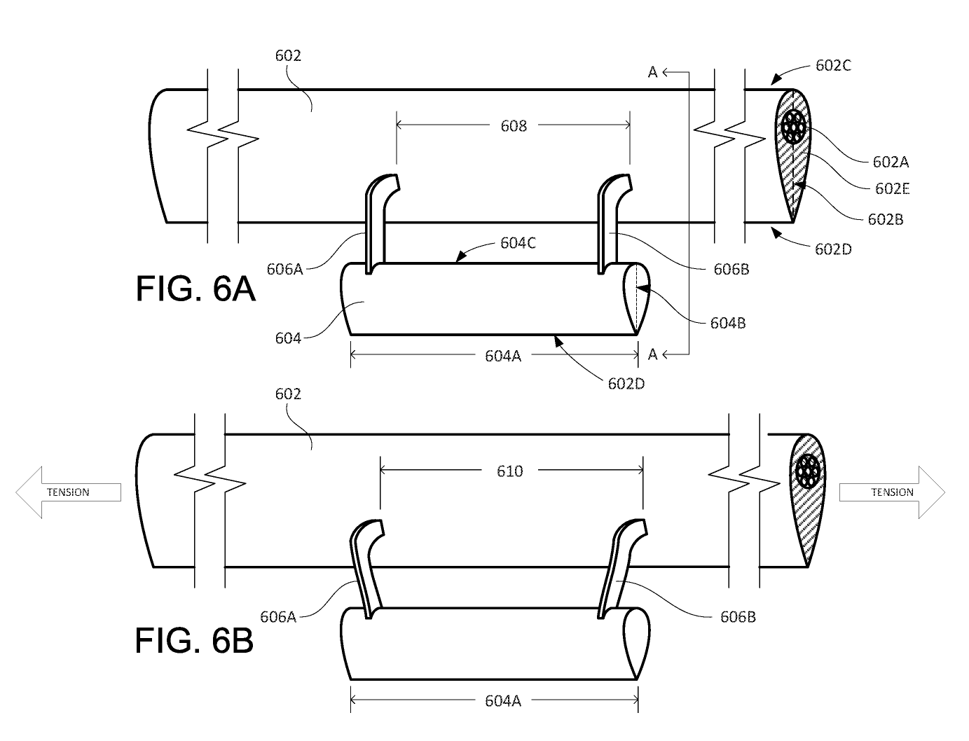

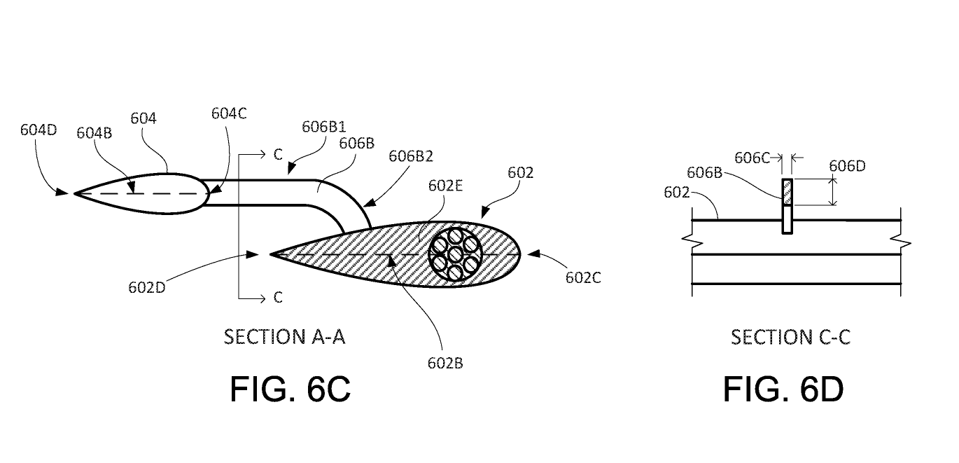

FIG. 6A depicts a portion of a faired tether and tail in an unstretched condition, according to an example embodiment. The tether 602 includes a tether body 602E and a core 602A running through the body. As illustrated, the tether body 602E may be solid (e.g., a vulcanizing rubber or silicone), or in another embodiment the tether body may take the form of a non-solid structure (e.g., ribs, or various fill materials and voids). The tether body 602E may be uniform or may be comprised of various materials. Additionally, the tether body 602E may include an external jacket material that is different than one or more internal structural materials. As illustrated, the core 602A may be an electrical conductor, or in another embodiment the core 602 may include one or more electrical conductors and/or strength members. The core 602A may provide a significant contribution to the tensile strength and/or shear strength of the tether 602. Strength members within the core 602A may take various different forms in various different embodiments. For example, in some embodiments, the core 602A may include pultruded fiber rod, carbon fiber rod (e.g., T700 or T800), dry strength fiber (e.g., poly p-pheyylene-2, 6-benzoobisoxazole (“PBO”), such as Zylon), fiberglass, one or more metals (e.g., aluminum), epoxy, and/or a combination of carbon fiber, fiberglass, and/or one or more metals. As one example, the core 602A may include a combination of fibers, such as a first carbon fiber having a first modulus and a second carbon fiber having a second modulus that is greater than the first modulus. As another example, the core 602A may include carbon fiber and fiberglass or epoxy. Further, the core 602A may include a matrix composite and/or carbon fiber and/or fiberglass, such as a metal matrix composite (e.g., aluminum matrix composite). The electrical conductor(s) in the core 602A may be configured to transmit electricity. For example, electrical conductor(s) may be configured for high-voltage AC or DC power transmission (e.g., greater than 1,000 volts). For instance, a plurality of electrical conductors in the core 602A may be configured to carry an AC or DC voltage of between 1 kilovolt and 5 kilovolts, or higher, and an associated power transmission current of between 50 amperes to 250 amperes.

The illustrated tether 602 is in the form of an airfoil shape, with a leading edge 602C, a trailing edge 602D, and a tether chord length 602B extending between the leading edge 602C and the trailing edge 602D. As illustrated, the tether 602 is a symmetric airfoil shape, such as a symmetric 4-digit NACA airfoil. In another embodiment, the tether 602 may be a different shape, such a different symmetric airfoil or a cambered airfoil, such as a cambered 4-digit NACA airfoil. Additionally or alternatively, the airfoil shape of the tether 602 may change along the length of the tether 602. The airfoil shape of the tether 602 may be integrally formed as part of the tether body 602E or may be the result in whole or in part of the jacket or other external component.

In the portion of tether 602 shown in FIG. 6A, two struts 606A and 606B couple a tail 604 to the tether 602. Multiple tails may be attached to the tether 602 along the length of the tether 602, as illustrated in FIG. 5. The tail 604 has a span length 604A and takes the form of an airfoil shape, with a leading edge 604C, a trailing edge 604D, and a tether chord length 604B extending between the leading edge 604C and the trailing edge 604D. As illustrated, the tail 604 has a symmetric airfoil shape, such as a symmetric 4-digit NACA airfoil. In another embodiment, the tail 604 may have a different shape, such a different symmetric airfoil or a cambered airfoil, such as a cambered 4-digit NACA airfoil. Additionally or alternatively, the airfoil shape of the tail 604 may change along the length of the tail 604. As illustrated further in FIG. 5, multiple tails, such as tail 604, may make up a tail set, where each tail in a respective tail set is identical, and/or has the same airfoil shape, span length, chord length, distance from the tether, and/or orientation. Tails in one tail set may take different forms or be positioned differently than tails in another tail set.

As illustrated in FIG. 6A, the struts 606A and 606B are fixedly attached to the tether 602 and separated along the length of the tether 602 by a distance 608. The struts 606A and 606B are also fixedly attached to the tail 604 at the leading edge 604C of the tail 604, although other attachment points are possible. The tail 604 is preferably oriented such that its leading edge 604C is nearer the tether 602 than its trailing edge 604D.

Turning to FIG. 6B, it depicts the tether 602 in a stretched condition. As an aerial vehicle attached to tether 602 flies, the tether 602 may stretch (lengthen) as a result of the tension between the aerial vehicle and the ground station. As a result, the distance 608 between the struts 606A and 606B in the untensioned condition in FIG. 6A will lengthen to the distance 610 in the tensioned conditioned illustrated in FIG. 6B. To accommodate this change in length, the struts 606A and 606B are preferably made of, or include, a compliant structure. As illustrated in FIG. 6B, the compliant structure of struts 606A and 606B deforms in relation to changes in the length of tether 602. To accommodate repeated stretching and contraction cycles of the tether 602 in response to the application and removal of tension to the tether 602, the compliant structure must allow the struts 606A and 606B to reversibly deform, such that the struts 606A and 606B can move repeatedly and cyclically between the conditions in FIG. 6A and FIG. 6B. The struts 606A and 606B may be formed from a compliant material such as a rubber, metal, plastic, or composite material that is reversibly deformable. The struts 606A and 606B could additionally incorporate a material or structural design that has a damping component, such as a viscoelastic polymer or coating, or a stranded structure that has internal components that slide relative to each other. This could help dissipate energy and prevent the system from oscillating or fluttering.

FIG. 6C depicts the Section A-A view of tether 602, as indicated in FIG. 6A. Strut 606B can be seen in profile view with a riser portion 606B2 extending up from the body of the tether 602. This riser portion 606B2 offsets the tail 604 above (in this view) the plane of the chord line 602B. Depending on the height of the riser portion 606B2, the entire tail 604 may be offset above the top of the tether 602, as is illustrated in FIG. 6C. However, in another embodiment, the tail 604 may be offset such that only a portion of the tail 604 is above the chord line 602B or the top of the tether 602. As illustrated, the riser portion 606B2 extends outward from the tether body 602E at approximately a perpendicular angle from the top external surface of the tether body 602E at the attachment point, and at some angle less than 90° degrees relative to the illustrated chord length 602B. In other embodiments, the angle of the riser portion 606B2 relative to the tether body 602E or chord length 602B may be different than as depicted in this embodiment.

In the illustrated embodiment, the riser portion 606B2 transitions into an extension portion 606B1 that extends in a trailing direction (i.e., rearward or in the general direction of the trailing edge 602D). The extension portion 606B1 offsets the tail 604 behind (in this view) the trailing edge 602D of the tether. Depending on the length of the extension portion 606B1, the entire tail 604 may be offset behind the trailing edge 602D of the tether 602, as is illustrated in FIG. 6C. However, in another embodiment, the tail 604 may be offset such that only a portion of the tail 604 is behind the trailing edge 602D. The distance of the tail 604 from the tether 602 may be considered as a function of the offset of the tail 604 above the tether 602, the offset of the tail 604 behind the tether 602, or both.

FIG. 6D depicts the Section C-C view of tether 602, as indicated in FIG. 6C.

The cross-section of strut 606B is illustrated with a height 606D and a width 606C in the extension portion 606B1. As illustrated, the strut 606B (as well as the strut 606A) has a height-to-width ratio greater than 1.0, which reduces flutter or vertical movement of the tail 604 relative to the tether 602 while allowing deformable flexibility in the struts 606A and 606B to accommodate stretch and contraction of the tether 602 along its length.

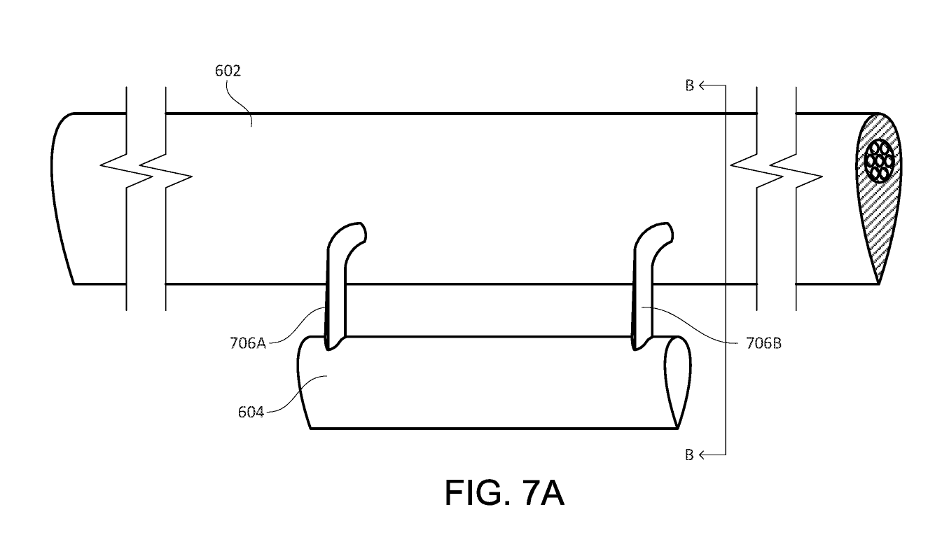

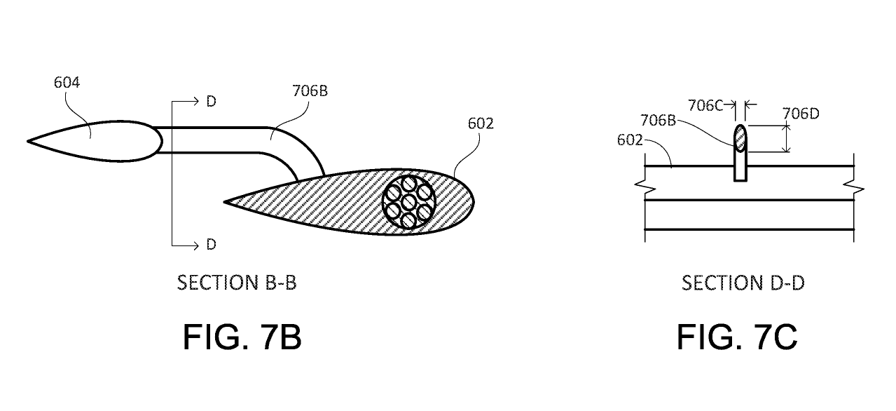

FIG. 7A shows a similar arrangement to FIG. 6A, except that the rectangular (in cross-section) struts 606A and 606B have been replaced with ellipsoidal struts 706A and 706B, as can be further seen in FIGS. 7B and 7C. Again, the struts 706A and 706B have a height-to-width ratio greater than 1.0, where 706D is greater than 706C, for the benefits described above.

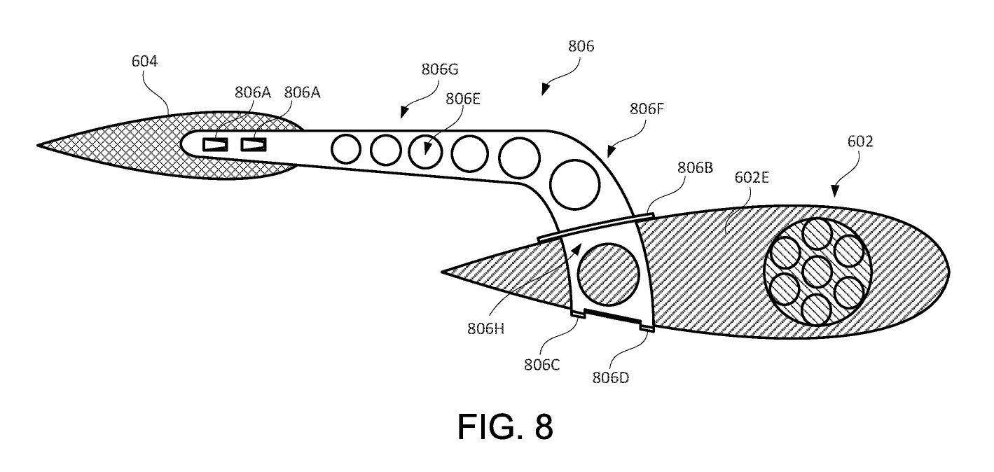

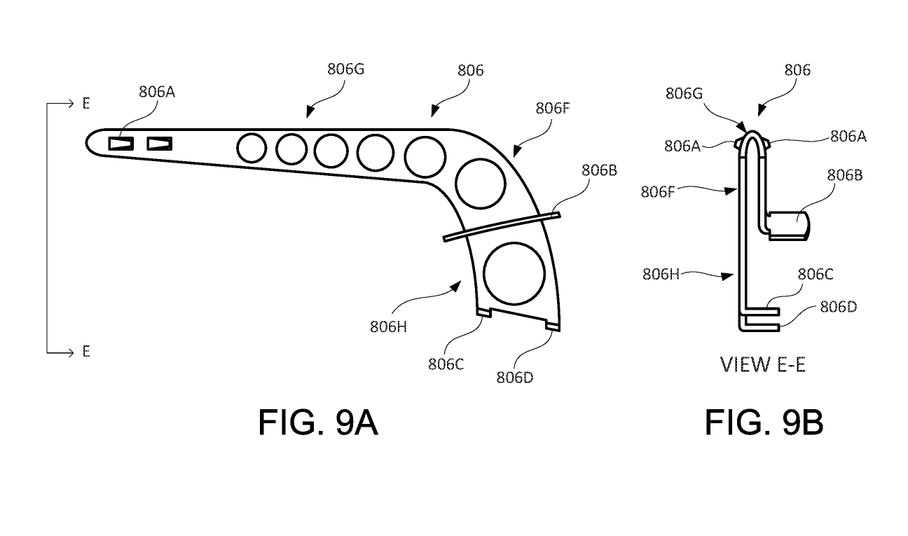

FIG. 8 depicts another strut embodiment 806 arranged in a section view of tether 602. Strut 806 is similar to struts 606A or 706A with a riser portion 806F and an extension portion 806G. Strut 806 also includes an interior segment 806H extending through the tether body 602E. Bottom locking tabs 806C and 806D extend outward at an angle relative to the interior segment 806H (as further depicted in FIG. 9B) and along a bottom surface of the tether 602, serving to anchor the strut 806 into the tether 602. Similarly, top locking tab 806B extends outward at an angle relative to the interior segment 806H (as further depicted in FIG. 9B) and along a top surface of the tether 602, serving to anchor the strut 806 into the tether 602. Holes 806E or other relief features may be formed into the strut 806 to reduce the weight and cross-section presented to air moving transversely across the strut 806. Locking spurs 806A may be formed into the end of the extension portion 806G than is inserted into the tail 604, serving to anchor the strut 806 into the tail.

FIGS. 9A and 9B depict a side view and a rear view of strut 806, respectively. FIG. 9B illustrates that strut 806 may be formed from a folded sheet material, such as sheet metal. The interior portion 806H is illustrated as formed by a single layer of the sheet material, and the riser portion 806F and extension portion 806G are illustrated as formed by a folded double layer of the sheet material.

Using struts, such as 606A, 706A, and 806, to offset the tail above the tether chord 602B and partially or completely behind the trailing edge 602 creates a number of advantages. It puts the tail 604 in clean (or cleaner) air flow during tether flight and out of the downwash of the tether 602. As a result, the apparent angle of attack of the tail 604 is higher and more effective than non-offset locations. As another advantage, the trim of the tether and tail system may be set such that the equilibrium point of the tether's 602 air foil shape is at some specific angle of attack and can generate a net lifting force. That lifting force may act to counter centrifugal forces on the tether that result from flying around in a circle. This could also be aided by using a non-symmetrical airfoil shape for the tether 602. As another advantage, the tether 602 may be conveniently wrapped onto a tether drum at the ground station when not actively flying. The offset position of tail 604 allows the tether 602 to wrap and lay flat against the drum while the tail 604 can rest on top of the previous wrap. This allows the tether to take up less space on the drum. Additionally, attaching the struts 606A and 606B to just one side of the tether 602 leaves the other side clean for resting against the drum or rolling through a levelwind. Preferably, the span length of the tails 604 are short enough so that they can be wrapped onto a winch drum with minimal bending stress.

FIGS. 8, 9A, and 9B illustrate an embodiment for attaching the struts to the tether 602 and tail 604. However, the struts could alternatively or additionally be attached in other ways. For example, they could be secured with fasteners (e.g. bolts or rivets), with adhesive, or via sonic welding.

Other embodiments are also considered for the struts. For example, to conserve weight and improve transverse air flow across the struts, they could also be formed in a truss design and/or have varying thickness across the strut. For example, the strut could be thicker towards the tether 602, where the moment acting on the strut is greatest, and thinner near the tail 604.

Additionally, while two struts per tail 604 are illustrated, more than two struts per tail could be employed. Additionally or alternatively, instead of all the struts on a tail 604 being parallel to each other when the tether is in an untensioned state, one or more of the struts could be angled relative to one or more of the other struts. For example, a zig-zag pattern could be used, or two struts could be oriented as in the sides of a trapezoid. Additionally or alternatively, the struts could be angled so that they align more with the local air flow direction resulting from the span-wise contribution to local air flow that comes from the ambient wind.

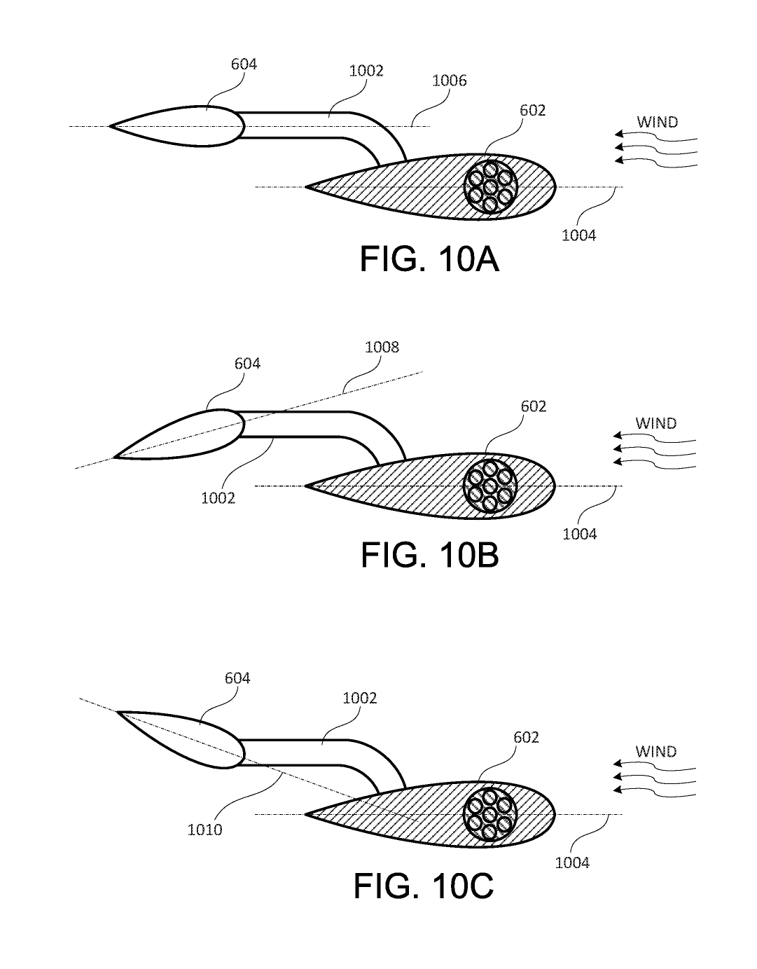

FIG. 10A depicts a tether 602 and tail 604 connected by strut 1002, where the pitch of the tail 604 and the pitch of the tether 602 are the same. Line 1004 illustrates a pitch angle of the tether 602 when the tether 602 is oriented into the wind. The line 1004 is along the chord length between the leading edge and trailing edge of the tether 602. Line 1006 illustrates a pitch angle of the tail 604 and is along the chord length between the leading edge and trailing edge of the tail 604. As illustrated, lines 1004 and 1006 are parallel and therefore the pitch angle of the tail 604 and the pitch angle of the tether 602 are the same. FIGS. 10B and 10C are substantially similar, except FIG. 10B illustrates a pitch angle of the tail 604 at line 1008 greater than the pitch angle of the tether 602, and FIG. 10C illustrates a pitch angle of the tail 604 at line 1010 less than the pitch angle of the tether 602

Although example tether and tail systems described herein may be used in AWTs, the systems described herein may be used for other applications, including overhead power transmission, aerostats, subsea and marine applications including offshore drilling and remotely operated underwater vehicles (ROVs), towing, mining, and/or bridges, among other possibilities.

### III. CONCLUSION

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are contemplated herein.

What is claimed is:

1. A system comprising:
a ground station;
an aerial vehicle;
a tether coupled between the ground station and the aerial vehicle, the tether comprising a tether body and an electrical conductor, wherein the tether takes the form of a first airfoil shape comprising a leading edge of the tether, a trailing edge of the tether, and a tether chord length; and
a plurality of tails, wherein each tail takes the form of a respective airfoil shape comprising, respectively, a chord length, a span length, a leading edge, and a trailing edge,
wherein each tail is disposed at a respective distance from the tether and coupled to the tether by at least two struts, and
wherein each tail is oriented such that the leading edge of the respective tail is nearer the tether than the trailing edge of the respective tail.

2. The system of claim 1, further comprising a plurality of tail sets, wherein each tail set contains at least one tail, wherein each tail in a respective tail set has the same respective airfoil shape as each other tail in the respective tail set, and wherein the airfoil shape for each tail in the respective tail set is different than the respective airfoil shapes for the tails in other tail sets.

3. The system of claim 2, wherein each tail in the respective tail set has the same respective span length as each other tail in the respective tail set, and wherein the span length for each tail in the respective tail set is different than the respective span length for tails in other tail sets.

4. The system of claim 3, further comprising a first tail set and a second tail set of the plurality of tail sets, wherein the first tail set is located nearer to the ground station along the tether than the second set, wherein the respective span length for each tail in the first tail set is longer than the respective span length for each tail in the second set.

5. The system of claim 2, wherein each tail in the respective tail set has the same respective chord length as each other tail in the respective tail set, and wherein the respective chord length for each tail in the respective tail set is different than the respective chord length for the tails in other tail sets.

6. The system of claim 5, further comprising a first tail set and a second tail set, wherein the first tail set is located nearer to the ground station along the tether than the second set, wherein the respective chord length for each tail in the first tail set is longer than the respective chord length for each tail in the second set.

7. The system of claim 1, further comprising a plurality of tail sets, wherein each tail set contains at least one tail, wherein the respective distance from the tether for each tail in a respective tail set is the same for each tail in the respective tail set and different than the respective distance from the tether for each tail in different tail sets.

8. The system of claim 7, further comprising a first tail set and a second tail set of the plurality of tail sets, wherein the first tail set is located nearer to the ground station along the tether than the second set, wherein the respective distance from the tether for each tail in the first tail set is longer than the respective distance from the tether for each tail in the second set.

9. The system of claim 1, wherein the tether is configured such that an overall length of the tether between the ground station and the aerial vehicle changes in relation to a change in tension in the tether between aerial vehicle and the ground station, wherein each of the struts connecting each respective tail to the tether are each fixedly attached to the tether and the respective tail, and wherein each strut comprises a compliant structure that is configured to reversibly deform in relation to the change in the overall length of the tether.

10. The system of claim 9, wherein the system is configured such that a respective distance along the length of the tether between the at least two struts connecting each respective tail to the tether changes in relation to the change in the overall length of the tether.

11. The system of claim 1, wherein the tether chord length defines a tether pitch angle relative to a wind acting on the tether when the leading edge of the tether is oriented into the wind, wherein the respective chord length of a tail of the plurality of tails defines a respective tail pitch angle, and wherein the respective tail pitch angle is the same as the tether pitch angle.

11. The system of claim 1, wherein the tether chord length defines a tether pitch angle relative to a wind acting on the tether when the leading edge of the tether is oriented into the wind, wherein the respective chord length of a tail of the plurality of tails defines a respective tail pitch angle of the tail, and wherein the respective tail pitch angle is greater than the tether pitch angle.

12. The system of claim 1, wherein the tether chord length defines a tether pitch angle relative to a wind acting on the tether when the leading edge of the tether is oriented into the wind, wherein the respective chord length of a tail of the plurality of tails defines a respective tail pitch angle, and wherein the respective tail pitch angle is less than the tether pitch angle.

13. The system of claim 1, wherein each strut comprises:
a riser portion coupled to the tether and extending outward from the tether body at a first angle relative to the tether chord length; and
an extension portion between the riser portion and the respective tail, wherein the extension portion extends from the riser portion in a trailing direction.

14. A system comprising:
a tether comprising a tether body and an electrical conductor, wherein the tether takes the form of a first airfoil shape comprising a leading edge of the tether, a trailing edge of the tether, and a tether chord length; and
a strut, the strut comprising:
an interior segment extending through the tether body;
a bottom locking tab extending at a first angle relative to the interior segment and along a first exterior surface of the tether body;
a riser portion extending outward from the tether body at a second angle to the tether chord length;
a top locking tab extending at a third angle from the riser portion and along a second exterior surface of the tether opposite the first exterior surface of the tether; and
an extension portion extending from the riser portion in a trailing direction.

15. The system of claim 14, wherein the strut comprises a sheet material, wherein the interior segment comprises a single layer of the sheet material, and wherein the riser portion comprises a folded double layer of the sheet material.

16. The system of claim 15, wherein the extension portion comprises a folded double layer of the sheet material.

17. The system of claim 15, wherein the folded sheet material comprises metal.

18. The system of claim 14 further comprising a tail, wherein the tail takes the form of an airfoil shape comprising a leading edge of the tail and a trailing edge of the tail, wherein the strut extends into the tail.

19. The system of claim 18, wherein the strut further comprises a locking spur extending outward from a portion of the extension portion and into an interior portion of the tail.

20. The system of claim 18, wherein the strut extends into the tail through the leading edge of the tail.
